(19) United States
(12) Patent Application Publication
(10) Pub. No.: US 2006/0271275 A1
(43) Pub. Date: Nov. 30, 2006

(54) System and method for notification and correction of constraint violations in vehicles

(76) Inventor: Paridhi Verma, Mount Kisco, NY (US)

Correspondence Address: Whitham, Curtis, & Christofferson, P.C., Suite 340, 11491 Sunset Hills Road, Reston, VA, 20190, US

(21) Appl. No.: 11/137,370

(22) Filed: May 26, 2005

(51) Int. Cl. G01C 21/26

(52) U.S. Cl. 701/200; 340/996

(57) ABSTRACT

The present invention provides a system and method for notifying vehicle operators and owners of violations of constraints, which may be road rules or other vehicle operating parameters. Such constraints by vary from one geographic location to another, or such constraints may impose geographic limitations on the operator. A vehicle computer receives and processes vehicle data, geographic data, and constraint data in order to identify constraint violations and/or to project potential constraint violations which have not yet occurred. Notification is then provided of violations and/or projected violations.

### BACKGROUND OF THE INVENTION

1. Field of the Invention

The present invention generally relates to vehicle operation and, more particularly, to the operation of vehicles that move from one geographic location in which a certain set of specific rules governs vehicle operation to another geographic location in which another set of specific rules governs vehicle operation. The present invention enables prompt notification of changes in applicable rules, and of rule violations, as a vehicle moves from one geographic location to another. Furthermore, the invention enables automated corrective actions to prevent the occurrence of a violation, whenever possible.

2. Background Description

Operators of automobiles and other vehicles must comply with various legal rules and other constraints as they travel through different roads and systems and as they move from one geographically determined jurisdiction to another. Examples of constraints of which vehicle operators must be aware include, without limitation, speed limits, one-way streets, limitations on access to roads by vehicle height and weight, limitations on access to road by the nature of traffic (e.g., commercial traffic not permitted), and various other parameters.

Some vehicle operation constraints may be defined on a statewide basis. Examples of such constraints include, without limitation, requirements for rear-facing seat belts for young children may be defined in terms of different age and/or weight requirements in different states. Other vehicle operation constraints may be defined more locally. Examples of such constraints include, without limitation, speed limits on a single road, which may change as a vehicle transits across adjacent townships or counties. Still other vehicle operation constraints may be imposed by contract. Examples of such constraints include, without limitation, restrictions imposed by a car or truck rental company to limit use of a rented vehicle to a particular state, region, or country (with penalties imposed on drivers who take vehicles out of the designated areas). Further vehicle operation constraints may be imposed by temporary or permanent Federal regulation. Examples of such constraints include, without limitation, prohibitions against unauthorized aircraft flying in restricted airspace, e.g., over Washington, D.C., and certain military facilities, as well as prohibitions against taking unauthorized watercraft into certain waters subject to temporary or permanent military control.

Previously, vehicle operators have not been able to receive notification of changes in applicable vehicle operation constraints as they move from one geographic location to another. This may be especially problematic for operators taking vehicles into areas with which they may be unfamiliar. By way of example, but not limitation, an automobile or truck driver may be unaware that he or she is approaching a poorly marked change in the speed limit. Such a driver might be caught in a classic speed trap without some warning that the vehicle's speed and direction of travel were bringing the driver toward such an obstacle. Another example would be a small airplane (or watercraft) operator flying on a path leading into restricted airspace (or waters) unaware that he or she was doing so. Further examples may readily be compiled.

Archival devices have been available to record telemetric data of a vehicle, such as speed or other indicators of a vehicle's operational state. Such devices, however, are not aware of either a vehicle's geographic location or various legal or other constraints applicable to vehicle operation, which may change as geographic location changes.

GPS-based navigational systems have also been available, which combine the position-sensing GPS technology with a map database to provide functions such as routes between several points, locations of near restaurants, and so forth. Even a GPS-based system including data as to various legal or other constraints applicable to a vehicle, however, is not aware of the operational state of the vehicle and is, therefore, not able to notify a vehicle operator when the operational state of the vehicle is inconsistent with, or is about to become inconsistent with, geography-specific vehicle operation constraints.

A combination of GPS technology and a vehicle's telemetry information has been used for providing an analysis of a limited set of constraints violations after the violations have occurred. U.S. Pat. No. 6,865,457, for example, provides an apparatus that can record GPS information and speed at different points of a vehicle's travel. This information is then used after the trip is completed to analyze any possible speed limit violations that the vehicle operator may have committed, primarily with a view towards determining insurance risk. However, the state of the art does not provide a way for a driver to become aware of potential violations during vehicle operation, for the purpose of avoiding such violations. Nor does the state of the art provide a way for the system to automatically correct any potential violation.

### SUMMARY OF THE INVENTION

It is therefore an object of the present invention to provide a system and method by which the operator of a vehicle can be notified when a vehicle is violating an applicable constraint, or is about to come into violation of an applicable constraint as a result of changes in applicable constraints resulting from the vehicle's movement from one geographic location to another. It is also an object of the present invention to provide a system and method whereby constraint violations may automatically be corrected. The present invention is applicable to a wide variety of vehicles, including but not limited to automobiles, trucks, motorcycles, other on-road and off-road land vehicles, watercraft, aircraft, and so forth.

Another object of this invention is to provide a system and method by which a vehicle can take corrective actions to prevent any ongoing or anticipated violation of the legal or other constraints applicable to the operation of the vehicle. The corrective action is applicable in a wide variety of stages of vehicle operation, and can be applied to any component of a vehicle operation which can be controlled electronically by the vehicle's system.

Implementation of the present invention typically requires use of a computer (which may be onboard the vehicle or connected to the vehicle by a wireless networking capability) to process at least three distinct types of data:
Vehicle data, including but not limited to:
   Data as to predefined or static properties of the vehicle, including but not limited to weight, height, length, class of vehicle, number of axles, number of engines, draft, capacity, maximum speed and so forth; and
   Data as to the operational state of a vehicle, including but not limited to telemetric data as to vehicle speed, direction and/or trajectory of travel, turn signal use, which seats are occupied, whether seatbelts are in use, and so forth.
Geographic data as to the location of the vehicle, which may be obtained from a GPS system or another available means.
Data as to geography-specific rules and other constraints, which may be obtained by an available means including, but not limited to, a database onboard the vehicle or a database accessible to the vehicle by a wireless networking capability. Geography-specific constraints may include, but are not limited to, current date and time as well as road rules.

Taking the example of a system for on-road motor vehicle use, the database of geography-specific constraints would include the location of roads in addition to constraints applicable to motor vehicle operation on those roads. In a system for off-road motor vehicle use, by contrast, the database of geography-specific constraints may include location-specific data as to limits on where and in what manner a vehicle may be used, thus potentially defining virtual roads and virtual road rules in off-road areas in order to minimize any environmental impact. Similar approaches could be applied to aircraft and watercraft use.

Once data is made available for input to a computer, which may be located onboard a vehicle or made accessible to the vehicle by a wireless networking capability, data processing may accomplish the following:
Relate the geographic position of the vehicle to the geography-specific database of legal and other constraints in order to determine:
   Which constraints are currently applicable to vehicle operation.
Relate applicable constraints to the operational state of the vehicle to determine:
   Whether the current operational state of the vehicle is within applicable constraints.
Relate the geographic position of the vehicle, the geography-specific database of applicable constraints, and data as to the operational state of the vehicle to determine:
   Which, if any, constraints applicable to vehicle operation are about to change; and
   Whether the current operational state of the vehicle is within new constraints which are about to become applicable to vehicle operation, as determined by the location, speed, and direction of travel of the vehicle.

If it is determined that the current operational state of a vehicle is either outside of applicable constraints or outside of constraints about to become applicable to vehicle operation, the present invention may provide for the following responses, among others:
Notify the driver by any available means, including but not limited to synthesized speech or an audible tone.
Automatically bring the vehicle within the relevant constraints by any available means, such as by using a vehicle's cruise control system to adjust speed or by turning on a vehicle's headlights in order to comply with mandatory headlight use requirements under various conditions, such as when windshield wipers are in use.

To take an exemplary implementation, among other potential exemplary implementations, a GPS system may be used to map the position of an automobile to a road in the map database. There may also be a legal constraints database containing a database keyed by the road on which the user is currently driving, thus defining the different constraints currently applicable to the system. A constraint-taking system may take the position of the vehicle, predefined or static properties of the vehicle (such as weight, height, class of vehicle, number of axles, and so forth), the current operational state of the vehicle (such as speed, passenger seatbelt usage, number of seats occupied, and so forth). Such inputs may then be compared to a set of defined constraints to see if any constraints are being violated. If any constraint is violated, then the user may notified by means of synthesized speech, an audible tone, or other means. The synthesized speech to be used can be looked up from a table mapping the type of constraint violation to the speech that is to be used.

This exemplary implementation may be augmented with various optional enhancements including, without limitation, the following, each of which could also be used in connection with other implementations of the claimed invention:
A user can make a selection, via a dial or click-based interface, to specify a setting establishing a threshold over the speed limit at which the user wishes to be notified. Such setting can be stored and used as a default setting, either for a particular user or for all users of the vehicle. This allows a user or vehicle owner to select whether drivers are to be allowed, before notification, to drive 5 mph below the speed limit, 10 mph below the speed limit, 5 mph over the speed limit, or 10 mph over the speed limit, and so forth. Other types of notifications may be set differently. For example, notification of a speed limit change may be set to be given a certain period of time (e.g., 30 seconds, 60 seconds) before the vehicle enters the new speed limit zone, based on the current speed of the vehicle and the distance to the new speed zone.
A vehicle owner may be able to program owner-specific constraints (e.g. states in which car is allowed to be operated, or the type of vehicle, etc.) which cannot be overridden by a non-owner user.
A storage device may be employed to record user violations of constraints.

The system and method of the present invention may thus be able, by way of example and not limitation, to do the following:
Notify an automobile driver by audible means (such as synthesized speech or beeps) that vehicle speed exceeds the local speed limit by, for example, 5 or 10 mph or some other user-elected amount;
Notify the driver of a commercial truck that the vehicle has moved onto a road which does not allow commercial traffic, or that the use of the truck's turn signal indicates that the driver intends to move the vehicle onto a such a road;
Notify a motor vehicle operator that the vehicle has entered a jurisdiction prohibiting motor vehicle operators from using hands-off and hands-on cell phones;
Notify the driver of a rented vehicle that the vehicle has crossed beyond the limits within which the vehicle is permitted to travel pursuant to the rental agreement; and/or
Notify the driver and passenger of a motor vehicle in which a passenger is occupying a seat without a seatbelt that the vehicle has crossed into a jurisdiction where passengers are required to use their seatbelts.

The present invention thus provides a system and method for notification of constraint violations in vehicles, comprising: a computer receiving and processing data and instructions as inputs and signals as outputs, the computer being connected to or in communication with a vehicle. The data inputs describe vehicle data, geographic data, and constraint data, wherein the vehicle data describe at least one of: static properties of the vehicle and the vehicle's operational state. The geographic data describe the location of the vehicle. The constraint data describe geography-specific constraints applicable to vehicle operation. The instructions describe selections for processing said inputs or outputs. The outputs provide notification of a constraint violation to a vehicle operator during operation.

The computer may be onboard the vehicle may or may be connected to the vehicle by a wireless network. The geographic data inputs may or may not include global positioning satellite data. The constraint data may or may not be located onboard the vehicle and may or may not be accessible to the computer by a network. The constraint data may or may not exclude speed limit data. Instructions may or may not be programmable and may or may not include driver preferences and/or owner constraints. The output signals may or may not trigger notification to an automated control for correction of the constraint violation, and/or to a storage device to record the constraint violation. The constraint violation may be one which is projected as likely to occur based on vehicle data, geographic data, and constraint data, even though it has not yet occurred.

The present invention also provides a system and method for proactive correction of constraint violations in vehicles, comprising: a computer receiving and processing data and instructions as inputs and signals as outputs, the computer being connected to or in communication with a vehicle. The data inputs describe vehicle data, geographic data, and constraint data, wherein the vehicle data describe at least one of: static properties of the vehicle and the vehicle's operational state. The geographic data describe the location of the vehicle. The constraint data describe geography-specific constraints applicable to vehicle operation. The instructions describe selections for processing inputs and outputs. The outputs initiate corrective operations to the state of the vehicle to prevent a constraint violation, such as may be done through automation.

Applications of the correction aspect of present invention include, but are not limited to:
Automatic adjustment of cruise control speeds to conform to speed limit changes;
Automatic turning on of lights in specific areas, including but not limited to tunnels; and
Automatic adjusting of transmission to account for road grade.

With regard to automatic adjustment of cruise control speeds, the present invention may, by way of example and not limitation, determine that a vehicle is operating at a speed in excess of a road's speed limit constraints, or in excess of speed limit constraints that are about to become applicable to the vehicle as the vehicle crosses a county line. If cruise control is enabled, the vehicle may take steps to bring the speed within the legally required range. In one exemplary implementation, the present invention may compute the difference between the current speed of the vehicle and the speed set on the cruise control. When the vehicle reaches a zone with a different speed limit, the system may adjust the speed limit to take the new legal speed limit into account. By way of example, and not limitation, the present invention may be set to maintain a constant difference between the set speed limit and the legal speed limit. Thus, if the cruise control is set at 50 mph in a 55 mph zone, the speed would be reset to 35 mph in a 40 mph zone. Alternatively, the present invention may be set to employ a proportional formula. In that case, if the cruise control was set at 50 mph in a 55 mph zone (i.e., 10% below the speed limit) then it may be reset to 36 mph in a 40 mph zone (i.e., ten percent below the new speed limit).

When a vehicle is driving below the posted minimum speed, a notification may be provided to the user. If cruise control is set, vehicle speed may be reset to the minimum value if a speed limit change has brought the cruise control speed below the minimum value. On the other hand, if cruise control is not set, a warning may be provided to the user. In addition, the present invention may automatically turn on hazard blinkers if locally-applicable rules require hazard blinkers when is vehicle is operating below a minimum speed limit.

With regard to automatic turning on of lights in specific areas, the present invention may determine that a vehicle is in a zone, such as a tunnel, where legal constraints require use of headlights during the daytime, or when windshield wipers are in use. In such cases, the headlights may automatically be turned on. If GPS navigational driving directions are used, and an upcoming turn is indicated by the directions, then the present invention may automatically activate the appropriate turn signal at the legally mandated distance before the turn.

When a vehicle is equipped with automatic transmission, and a correlation of GPS position and maps indicates that the road is becoming steep, the present invention may automatically shift the vehicle into an appropriate gear to accommodate the steepness of the road. This may be of particular usefulness to trucks and other heavier vehicles, which tend to require more shifting of gears.

### BRIEF DESCRIPTION OF THE DRAWINGS

The foregoing and other objects, aspects and advantages will be better understood from the following detailed description of preferred embodiments of the invention with reference to the drawings, in which:

FIG. 1 is a representation of an automobile equipped with the present invention.

FIG. 2 is a representation of an exemplary embodiment of the present invention.

FIG. 3 is a representation of the embodiment of FIG. 2 in which a driver input module has been added.

FIG. 4 is a representation of the embodiment of FIG. 2 in which an owner interface module has been added.

FIG. 5 is a representation of the embodiment of FIG. 2 in which a storage device has been added.

FIG. 6 is a representation of the embodiment of FIG. 2 in which an automated control module has been added.

### DETAILED DESCRIPTION OF A PREFERRED EMBODIMENT OF THE INVENTION

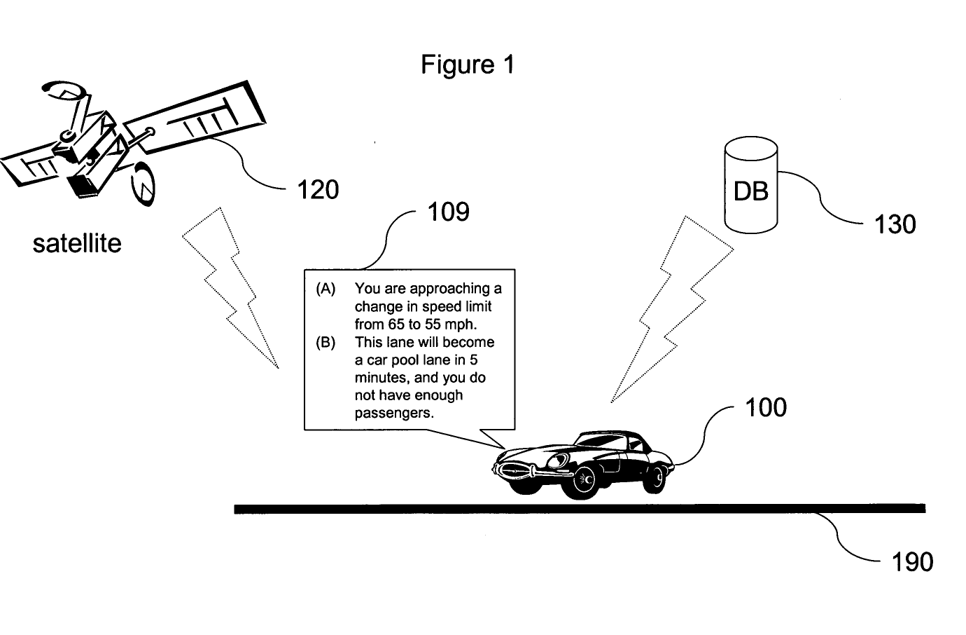

Referring now to the drawings, and more particularly to FIG. 1, there is shown an automobile 100 equipped with the present invention, receiving GPS data from a satellite 120 and data on geography-specific vehicle operation constraints from a database 130 which may be onboard the automobile or accessible to the vehicle by a wireless network. Processing of data from the automobile 100, GPS data from the satellite 120, and data from the constraints database 130 indicates that the automobile 100 is about to enter a zone on the road 190 on which it is traveling with different speed limits. As an example, the automobile 100 may be traveling at 60 mph and the speed limit on road 190 changes from 65 mph to 55 mph. Other applicable restrictions may include the circumstance that the automobile is in a lane which, in five minutes, will be subject to car pool restrictions for which the automobile is not carrying enough passengers to qualify. Notification 109 is then provided to the driver.

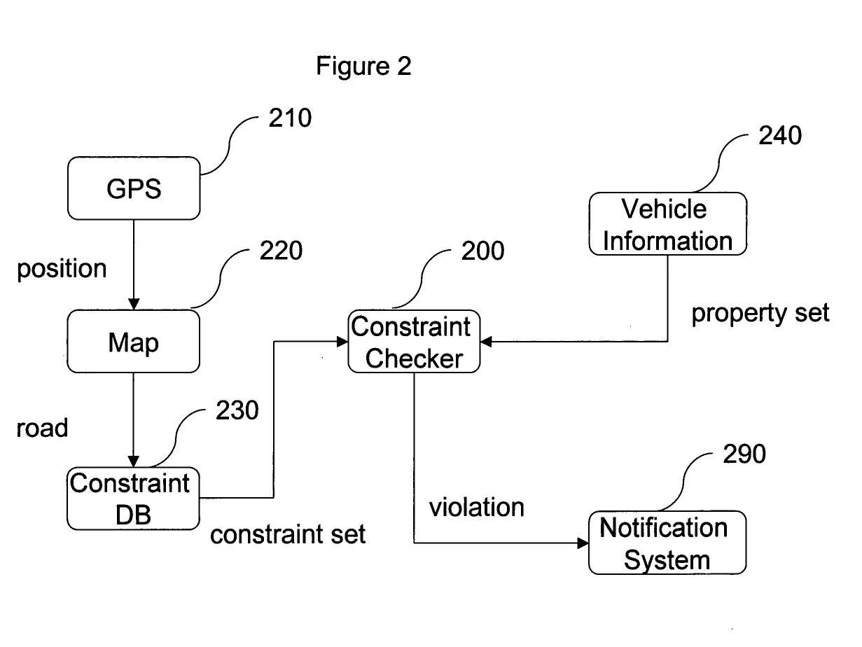

Referring now to FIG. 2, there is shown an exemplary embodiment of the present invention which can be deployed as a self-contained unit inside a vehicle. The embodiment consists of a GPS module 210 that is able to determine the position of the vehicle, which is then passed to a map database 220, which maps the GPS coordinates to the road on which the vehicle is operating. The representation of the road in the map database 220 contains information such as the name of the road, the township, the road segment identifier, state identification, and zip code. This information is mapped into the constraints database 230 which correlates map data to a set of legal constraints that the vehicle has to satisfy. Vehicle information 240 contains a set of vehicle properties (e.g., current speed, height, weight, classification, and so forth). The constraint checker 200 is a software program that compares the set of vehicle properties to the set of constraints. If any vehicle property is found not to be within the applicable constraint, the constraint checker 200 outputs a signal to a notification system 290 to inform the driver of the violation encountered.

For a system that ensures that motorists are notified whenever they exceed the posted speed limit, the constraint database 230 contains the speed limit on each segment of the road while the vehicle information module 240 consists of the speed read by the vehicle odometer. The notification system 290 could be a simple beep or a synthesized voice message. The system can detect when the effective set of constraints change as the vehicle crosses state boundaries, or other administrative boundaries. This can be identified by the effective set of constraints changing. It could then notify the driver of any pertinent constraints that may have changed. Similarly, by defining the set of constraints by owner, various types of legal restrictions and constraints can be uploaded into the constraints database, and the driver notified whenever he/she violates one of those constraints. Some examples of the constraints that can be provided within the constraints database include:
Speed limits (minimum and maximum) which a vehicle must obey on specific roads and areas.
Restricted spaces, which indicate areas where a vehicle must not be present, either due to governmental regulations, or due to limitations imposed in the contract of a rented vehicle.
Relationships between the different vehicle properties, e.g., the lights must be on if the wipers are on.
Constraints on the different vehicle properties depending on the location of the vehicle, e.g., the headlights of the vehicle must be on when it is in an area where the road passes through a tunnel.

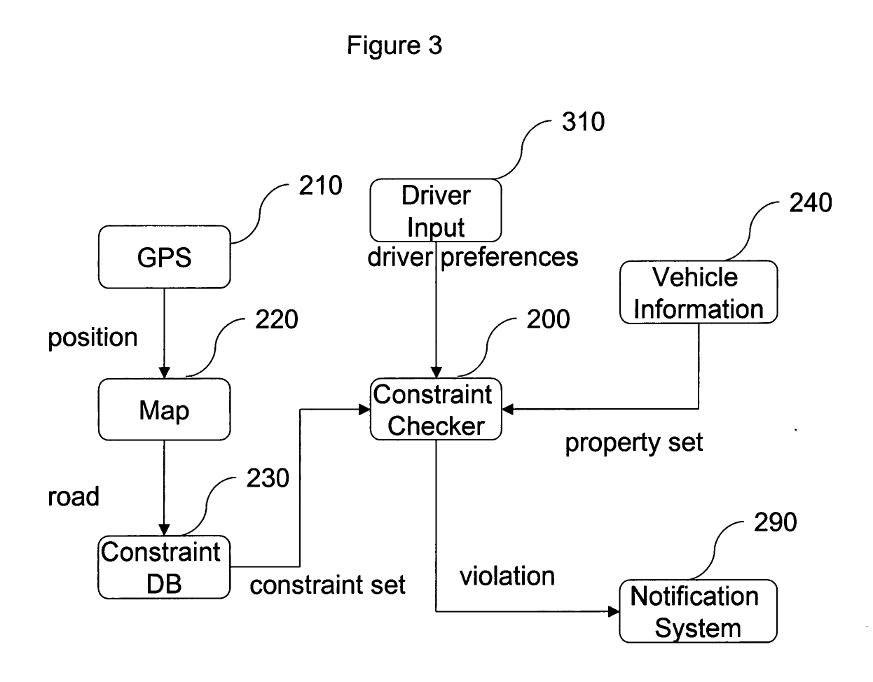

FIG. 3 shows the embodiment of FIG. 2 in which a driver input module 310 has been added to enable a user to specify preferences about how notification constraint violations should be handled. This system can incorporate user input specifying that the user is to receive speed limit constrain notifications at 5 mph below the speed limit, at the speed limit, at 5 mph above the speed limit, at 10 mph above the speed limit. The user input could be defined in various ways. One way to define input would be via a clicking device which may be set at 5 mph below the speed limit when the car is turned on. The user may click it multiple times to increment the limit by a threshold (e.g., 1 mph) on each click. A choice may be made to save user settings, and to use them as default settings the next time the engine is turned on, or not to save them. An alternative user input device could be a dial that can be used to select a desired threshold of notification.

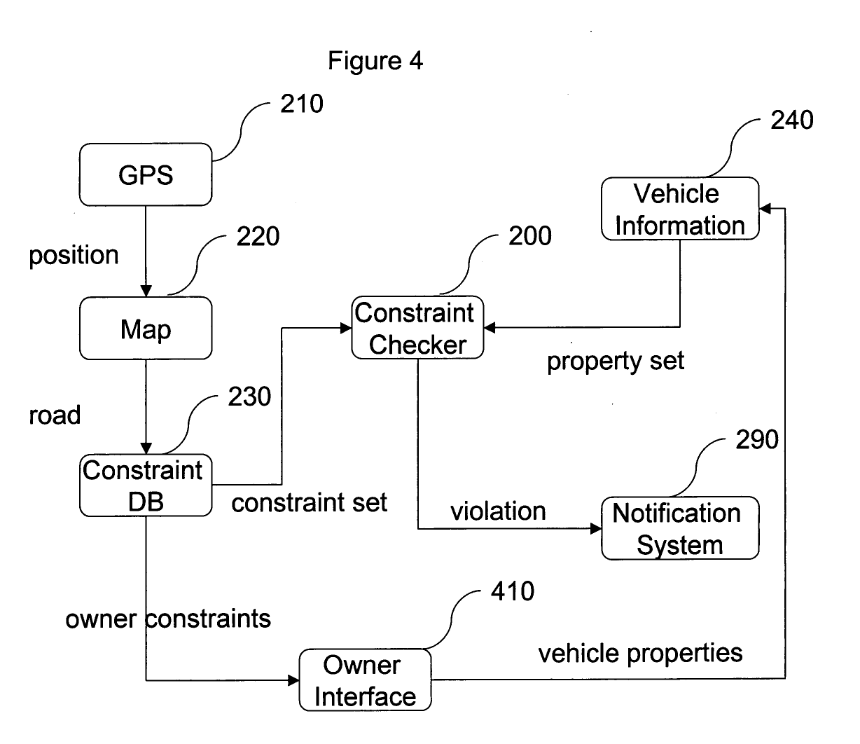

FIG. 4 shows the embodiment of FIG. 2 in which an owner interface module 410 has been added to enable the owner of a vehicle to define static vehicle properties and to introduce additional owner-defined constraints. The owner input module 410 may also be used to prevent users from modifying certain user settings.

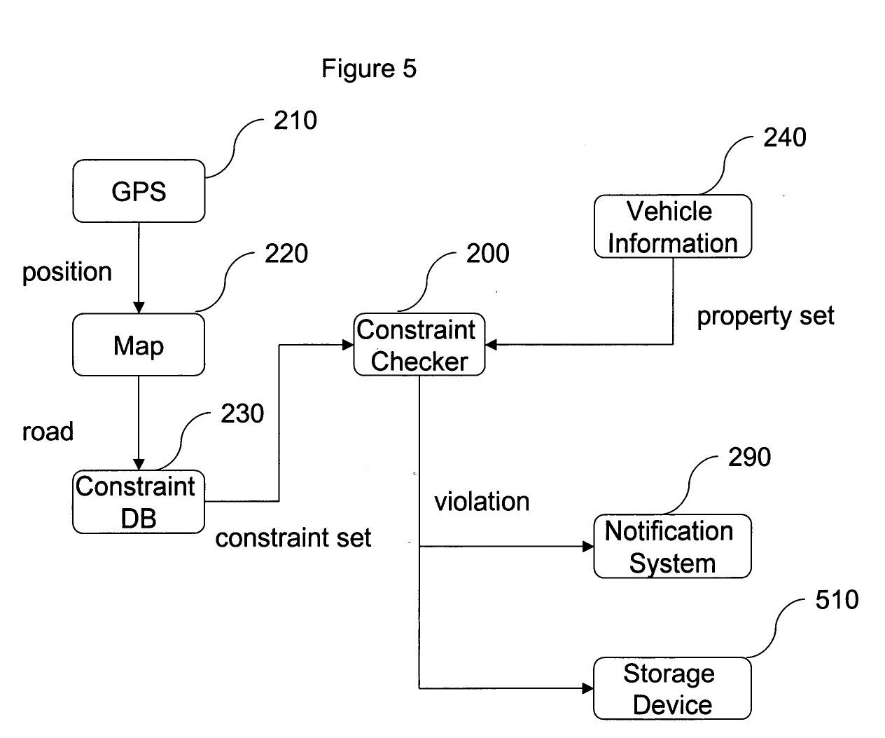

FIG. 5 shows the embodiment of FIG. 2 in which a storage device 510 has been added to record constraint violations for subsequent analysis.

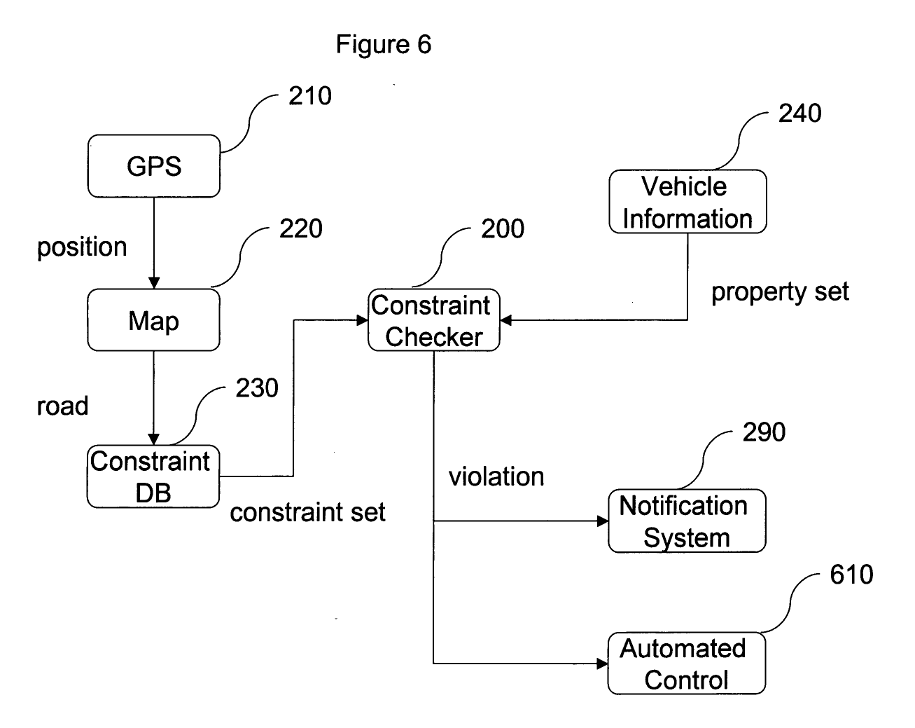

FIG. 6 shows the embodiment of FIG. 2 in which a automated control module 610 has been added to take corrective actions when any constraints may have been found to be violated.

While the invention has been described in terms of a set of preferred embodiments, those skilled in the art will recognize that the invention can be practiced with modification within the spirit and scope of the appended claims.

1. A system for notification of constraint violations in vehicles, comprising:
a computer receiving and processing data and instructions as inputs and signals as outputs;
said computer being connected to or in communication with a vehicle;
said data inputs describing vehicle data, geographic data, and constraint data, wherein
said vehicle data describe at least one of:
static properties of said vehicle and
said vehicle's operational state,
said geographic data describe the location of said vehicle, and
said constraint data describe geography-specific constraints applicable to vehicle operation;
said instructions describing selections for processing said inputs or outputs; and
said outputs providing notification of a constraint violation to a vehicle operator during operation.

2. The system according to claim 1, wherein said constraint data is located onboard the vehicle.

3. The system according to claim 1, wherein said constraint data is accessible to the computer by a network.

4. The system according to claim 1, wherein said constraint data do not include speed limit data.

5. The system according to claim 1, wherein said instructions are programmable.

6. The system according to claim 5, wherein said instructions are driver preferences.

7. The system according to claim 4, wherein said instructions are owner constraints.

8. The system according to claim 1, wherein said outputs trigger notification to an automated control for correction of said constraint violation.

9. The system according to claim 1, wherein said outputs trigger notification to a storage device to record said constraint violation.

10. The system according to claim 1, wherein said constraint violation is projected as likely to occur based on vehicle data, geographic data, and constraint data, but has not yet occurred.

11. A method for notification of constraint violations in vehicles, comprising the steps of:
using a computer to receive and process data and instructions as inputs and signals as outputs;
said computer being connected to or in communication with a vehicle;
said data inputs describing vehicle data, geographic data, and constraint data, wherein
said vehicle data describe at least one of:
static properties of said vehicle and
said vehicle's operational state,
said geographic data describe the location of said vehicle, and
said constraint data describe geography-specific rules and other constraints applicable to vehicle operation;
said instructions describing selections for processing said inputs or outputs; and
said output signals providing notification of a constraint violation to a vehicle operator during operation.

12. The method according to claim 11, wherein said constraint data is located onboard said vehicle.

13. The method according to claim 11, wherein said constraint data is accessible to said computer by a network.

14. The method according to claim 11, wherein said constraint data do not include speed limit data.

15. The method according to claim 11, wherein instructions are programmable.

16. The method according to claim 15, wherein said instructions are driver preferences.

17. The method according to claim 15, wherein said instructions are owner constraints.

18. The method according to claim 11, wherein said outputs trigger notification to an automated control for correction of said constraint violation.

19. The method according to claim 11, wherein said outputs trigger notification to a storage device to record said constraint violation.

20. The system according to claim 11, wherein said constraint violation is projected as likely to occur based on vehicle data, geographic data, and constraint data, but has not yet occurred.
